(19) United States
(12) Patent Application Publication
(10) Pub. No.: US 2025/0001896 A1
(43) Pub. Date: Jan. 2, 2025

(54) VEHICLE CHARGING MANAGEMENT DEVICE

(71) Applicant: SUBARU CORPORATION, Tokyo (JP)

(72) Inventor: Hitomi YAMAZAKI, Tokyo (JP)

(73) Assignee: SUBARU CORPORATION, Tokyo (JP)

(21) Appl. No.: 18/750,134

(22) Filed: Jun. 21, 2024

(30) Foreign Application Priority Data
Jun. 30, 2023 (JP) 2023-108043

(51) Int. Cl. B60L 53/66; H04N 21/466

(52) U.S. Cl. CPC B60L 53/66; H04N 21/4668; B60L 2260/58

(57) ABSTRACT

A vehicle charging management device for a vehicle includes one or more processors and a storage medium. The storage medium stores a program configured to be executed by the one or more processors. The program includes one or more commands. The one or more commands cause the one or more processors to perform a process for acquiring a remaining charging period of a battery of the vehicle up to a target charge level. The one or more commands cause the one or more processors to perform a process for acquiring a remaining playback period until an end of content playback in the vehicle. The one or more commands cause the one or more processors to perform a charging rate control process for controlling a charging rate of the battery to decrease when the remaining charging period is shorter than the remaining playback period.

### CROSS-REFERENCE TO RELATED APPLICATIONS

The present application claims priority from Japanese Patent Application No. 2023-108043 filed on Jun. 30, 2023, the entire contents of which are hereby incorporated by reference.

### BACKGROUND

The disclosure relates to a technical field of vehicle charging management devices.

Japanese Unexamined Patent Application Publication No. 2013-46524 discloses a technology in which, during a waiting period in charging of an electric vehicle, a service such as contents is provided to a user based on, for example, charging status information of the electric vehicle.

### SUMMARY

An aspect of the disclosure provides a vehicle charging management device for a vehicle. The vehicle charging management device includes one or more processors and a storage medium. The storage medium stores a program configured to be executed by the one or more processors. The program includes one or more commands. The one or more commands cause the one or more processors to perform a process for acquiring a remaining charging period of a battery of the vehicle up to a target charge level. The one or more commands cause the one or more processors to perform a process for acquiring a remaining playback period until an end of content playback in the vehicle. The one or more commands cause the one or more processors to perform a charging rate control process for controlling a charging rate of the battery to decrease when the remaining charging period is shorter than the remaining playback period.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a block diagram of the configuration of a vehicle according to an embodiment of the disclosure;

FIG. 2 is a flowchart of a processing example of a vehicle charging management device according to the embodiment; and

FIG. 3 is a flowchart of a processing example of the vehicle charging management device according to the embodiment.

### DETAILED DESCRIPTION

When a user returns to a vehicle before charging of the vehicle is completed, the user waits during a period before the completion of the charging. During the waiting period, contents may be played back by using electric power in a battery of the vehicle. When the content playback period is longer than the period before the completion of the charging, the contents are still played back after the charging is completed. Therefore, the battery charge level may decrease when the content playback has ended. In general, quick charging imposes a high load on the battery to deteriorate the battery.

It is desirable to control charging appropriately in consideration of a decrease in a charge level or a load on a battery when contents are played back during the charging. Vehicle Configuration

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

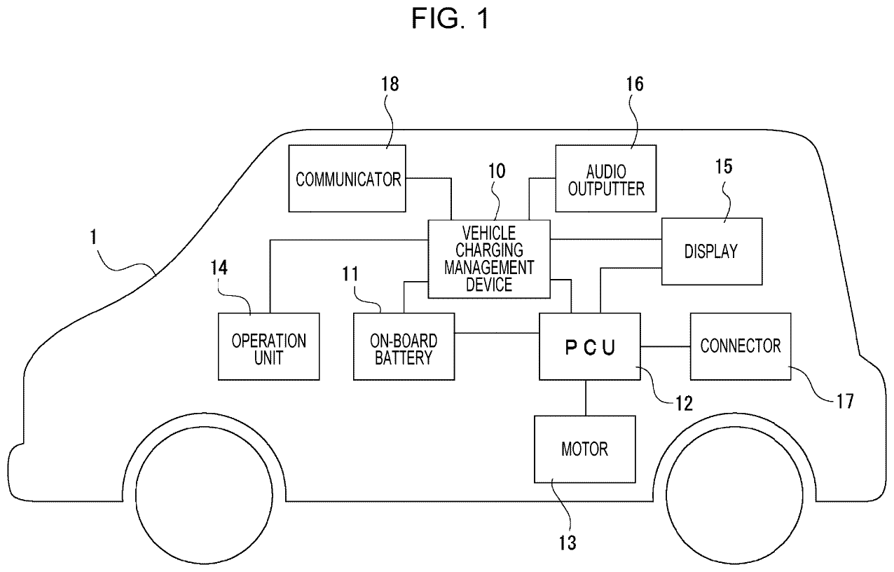

FIG. 1 illustrates a vehicle 1 including a vehicle charging management device 10 according to the embodiment. The vehicle 1 is an electric vehicle or a hybrid vehicle.

The vehicle 1 includes the vehicle charging management device 10, an on-board battery 11, a power control unit (PCU) 12, a motor 13, an operation unit 14, a display 15, an audio outputter 16, a connector 17, and a communicator 18.

FIG. 1 illustrates part of the configuration of the vehicle 1, and the vehicle 1 has various components for traveling and driving.

The vehicle charging management device 10 is constituted by one or more processors. For example, the vehicle charging management device 10 is constituted by one or more electronic control units (ECUs) in the vehicle 1. Examples of the ECU in the vehicle 1 include a traveling control ECU, a charging control ECU that controls charging of the on-board battery 11, an engine control ECU, a display control ECU that controls displaying on display devices (including meters etc.) in the vehicle 1, a drive assist ECU, an autonomous driving ECU, and an air conditioning control ECU. The vehicle charging management device 10 may be constituted by any ECU in the vehicle or by an ECU dedicated to functions of this embodiment.

The vehicle charging management device 10 includes a central processing unit (CPU), a read only memory (ROM), a random access memory (RAM), a non-volatile memory, and an input/output interface. The CPU performs various processes based on programs stored in the ROM or the non-volatile memory. The RAM stores as appropriate data etc. for various processes to be performed by the CPU.

The on-board battery 11 is a high-voltage battery for traveling of the vehicle 1. The on-board battery 11 supplies electric power for drive of wheels, electric power for operation of an air conditioner of the vehicle 1, and electric power for operation of other devices. FIG. 1 illustrates power supply for the drive of the wheels or for the display 15 from the on-board battery 11. Illustration is omitted for power supply for operation of the other parts.

The on-board battery 11 is charged with a current supplied from the PCU 12.

The on-board battery 11 supplies a power supply voltage for drive of the motor 13 to the PCU 12.

The PCU 12 includes an inverter and a AC/DC converter for the drive of the motor 13.

The PCU 12 generates an alternating current for the drive of the motor 13 based on the supplied power supply voltage, and supplies the alternating current to the motor 13. The PCU 12 controls torque of the motor 13 by controlling the alternating current. The PCU 12 may have an energy efficiency increasing function using regenerative energy generated by a regenerative braking function.

The motor 13 is a motor generator having a power generation function, and drives the wheels based on the supplied alternating current.

The operation unit 14 includes various operation elements such as buttons and levers disposed in front of a driver's seat of the vehicle 1. The operation unit 14 may include a multi-function display (MFD) having a touch panel function or a display of a navigation device.

The display 15 is a general term meaning, for example, an MFD installed in front of a driver who drives the vehicle 1 and other display devices that present information to the driver. The display 15 displays information based on detection signals from various sensors in the vehicle 1. The display 15 displays as appropriate various types of information such as a total vehicle traveling distance, an outside air temperature, and an instantaneous fuel efficiency. The display 15 can display map information and extracted route information. The display 15 can display contents described later.

The audio outputter 16 is a general term meaning various audio output devices such as loudspeakers installed in a vehicle cabin. The audio outputter 16 can output voice and sound based on contents displayed on the display 15.

The connector 17 is structured such that a charging plug of charging equipment such as a charger is insertable. The connector 17 outputs, to the PCU 12, an alternating-current voltage supplied via the inserted charging plug. The PCU 12 supplies, to the on-board battery 11, a direct-current voltage obtained by conversion in an AC/DC converter to charge the on-board battery 11.

The communicator 18 has an external communication function to perform communication via various transmission paths, such as network communication using the Internet etc., vehicle-to-vehicle communication, and road-to-vehicle communication.

### Processing Examples

Processes of the embodiment implemented by the vehicle charging management device 10 are described. The processes of the embodiment achieve appropriate charging control under the assumption that contents are played back by using electric power in the on-board battery 11 of the vehicle 1 that is being charged.

For example, the vehicle 1 is parked in a parking lot with a charger, and the on-board battery 11 is charged with the connector 17 coupled to a charging plug of the charger. The charging is completed when the charge level reaches a target charge level (e.g., full charge level) set by the user.

The user (occupant) of the vehicle 1 may return to the vehicle 1 before the charging of the on-board battery 11 is completed.

In the processes of the embodiment, the vehicle charging management device 10 causes the display 15 to play back contents when the user is in the vehicle 1 and the charging is not completed. The contents are played back over a predetermined period (playback period) and are, for example, video contents. As described later, the vehicle charging management device 10 recommends, based on the remaining charging period up to the target charge level, playback of contents with the remaining playback period longer than the remaining charging period.

The vehicle charging management device 10 manages the charging rate of the on-board battery 11 in response to the content playback. As described later, when the remaining charging period is shorter than the remaining content playback period, the vehicle charging management device 10 controls the charging rate to decrease to extend the remaining charging period based on the remaining playback period.

When the content playback has ended, for example, the charging up to the target charge level is completed and the user drives the vehicle 1 to depart from the parking lot.

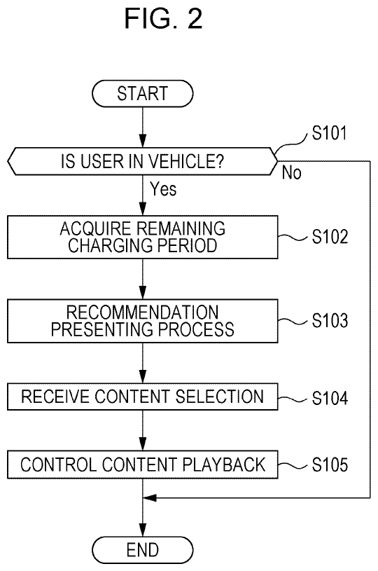

FIG. 2 illustrates an example of a process to be performed by the vehicle charging management device 10 to play back contents while the on-board battery 11 is being charged.

In Step S101, the vehicle charging management device 10 determines whether the user is in the vehicle 1. For example, the vehicle charging management device 10 determines whether the user is in the vehicle 1 based on a detection value from a sensor that detects a load on the seat in the vehicle 1, or image data from an image capturing device that captures an image of the vehicle cabin. The vehicle charging management device 10 may determine that the user is in the vehicle 1 when the vehicle 1 is powered ON by the user's operation. The method for determining whether the user is in the vehicle 1 is not limited to the above method, and may be changed as appropriate depending on the configuration of the vehicle 1.

When determination is made in Step S101 that the user is not in the vehicle 1, the vehicle charging management device 10 terminates the process of FIG. 2. The vehicle charging management device 10 periodically performs the process of FIG. 2, for example, every predetermined period until determination is made that the user is in the vehicle 1.

When determination is made in Step S101 that the user is in the vehicle 1, the vehicle charging management device 10 proceeds to Step S102.

In Step S102, the vehicle charging management device 10 acquires the remaining charging period of the on-board battery 11. The remaining charging period is a charging period remaining up to the target charge level. For example, the vehicle charging management device 10 calculates the remaining charging period based on information on a current state of charge (SOC) of the on-board battery 11, the SOC of the target charge level, and a current charging rate (amount of charging per unit time). The vehicle charging management device 10 may acquire the calculated remaining charging period from any other ECU in the vehicle 1 or an external device such as a charger control device instead of calculating the remaining charging period by itself.

In Step S103, the vehicle charging management device 10 performs a content recommendation presenting process. The content recommendation presenting process is a process for recommending, to the user, playback of contents with the remaining playback period longer than the remaining charging period.

As an example of the content recommendation presenting process, the vehicle charging management device 10 extracts contents with the remaining playback period longer than the remaining charging period acquired in Step S102, and controls the display 15 to present recommendation of playback of the extracted contents.

The remaining content playback period is a period remaining until the content playback ends. The remaining playback period may be the remaining period of contents being or to be played back. The remaining playback period serving as a condition for the content extraction in Step S103 in which no contents are being played back is the remaining period of contents to be played back and is, for example, a playback period of the whole contents or a period remaining until the end of playback of contents that were played back midway in the past. Therefore, the extracted contents are, for example, contents with a playback period longer than the remaining charging period or contents that were played back midway and has the remaining period longer than the remaining charging period.

To extract contents, the vehicle charging management device 10 acquires contents, for example, from an external device by network communication via the communicator 18. Therefore, the vehicle 1 can play back, for example, video contents provided by a subscription service contracted by the user. The vehicle charging management device 10 may acquire contents from a content group prestored in a storage of an ECU of the vehicle charging management device 10 or in the vehicle 1.

As an example of the presentation of recommendation of playback of the extracted contents, the vehicle charging management device 10 causes the display 15 to display a screen on which the user can select contents for playback, and presents at least one kind of extracted contents on the screen in a selectable manner.

In Step S104, the vehicle charging management device 10 receives the user's content selection operation.

The user may select contents for playback from among the contents recommended by the vehicle charging management device 10 or may select any other contents.

In Step S105, the vehicle charging management device 10 controls playback of the contents selected in response to the user's selection operation. For example, the vehicle charging management device 10 causes the display 15 to display the contents and, in a case of contents with voice and sound, causes the audio outputter 16 to output voice and sound.

When the content playback control is performed in S105, the vehicle charging management device 10 terminates the process of FIG. 2 and proceeds to a process for managing the charging rate of the on-board battery 11.

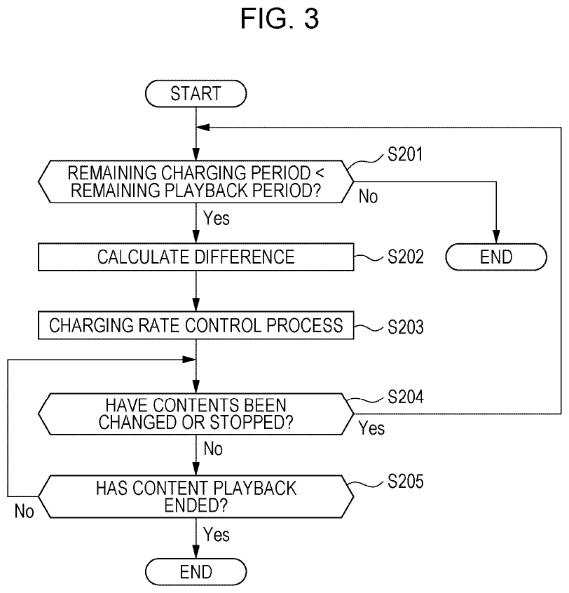

FIG. 3 illustrates an example of a process to be performed by the vehicle charging management device 10 to manage the charging rate of the on-board battery 11 based on the remaining content playback period.

In Step S201, the vehicle charging management device 10 determines whether the remaining charging period of the on-board battery 11 is shorter than the remaining playback period of the contents that are being played back.

When the determination is made in Step S201, the vehicle charging management device 10 newly acquires the remaining charging period of the on-board battery 11 for the determination. The vehicle charging management device 10 may use the remaining charging period acquired in Step S102 for the determination instead of newly acquiring the remaining charging period, but the user may spend a long period in selecting the contents and therefore the remaining charging period newly acquired when the determination is made is used to achieve control with higher accuracy.

When the determination is made in Step S201, the vehicle charging management device 10 acquires the remaining playback period of the contents that are being played back at the time of determination, and use the acquired remaining playback period for the determination. The remaining playback period in Step S201 in which the contents are being played back is the remaining period of contents that are being played back and is, for example, the period remaining from the time of determination to the end of the content playback. For example, the remaining playback period of contents that have just been played back at the time of determination is substantially equal to the playback period of the whole contents. The remaining playback period of contents that are played back midway at the time of determination is the period remaining from the time of determination to the end of the content playback.

When determination is made in Step S201 that the remaining charging period is not shorter than the remaining playback period, the vehicle charging management device 10 terminates the process of FIG. 3.

When determination is made in Step S201 that the remaining charging period is shorter than the remaining playback period (e.g., the remaining charging period is 5 minutes and the remaining playback period is 10 minutes), the vehicle charging management device 10 proceeds to Step S202.

In Step S202, the vehicle charging management device 10 calculates a difference (period) between the remaining charging period and the remaining playback period. For example, when the remaining charging period is 5 minutes and the remaining playback period is 10 minutes, “5 minutes” is calculated as the difference.

In Step S203, the vehicle charging management device 10 performs a charging rate control process. The charging rate control process is a process for controlling the charging rate (amount of charging per unit time) of the on-board battery 11 to decrease based on the remaining charging period and the remaining playback period. That is, the charging rate control process is a process for extending the remaining charging period.

For example, the vehicle charging management device 10 transmits, to the charging control ECU, control information based on the difference between the remaining charging period and the remaining playback period calculated in Step S202 to control the charging rate of the on-board battery 11 to decrease. For example, the vehicle charging management device 10 instructs the charging control ECU to make settings to reduce the charging current of the on-board battery 11. For example, when the remaining charging period is 5 minutes, the remaining playback period is 10 minutes, and the difference is 5 minutes, the charging rate of the on-board battery 11 is reduced to extend the remaining charging period by 5 minutes. In this case, the remaining charging period is “10 minutes” and substantially equal to the remaining playback period of the contents that are being played back.

The vehicle charging management device 10 may transmit the difference between the remaining charging period and the remaining playback period to the charging control ECU as the control information, or may transmit information calculated from the difference to the charging control ECU as the control information. For example, the vehicle charging management device 10 may perform control to set a charging rate based on the difference between the remaining charging period and the remaining playback period and transmit the set charging rate to the charging control ECU as the control information.

The charging control ECU reduces the charging rate by limiting the charging current to flow to the on-board battery 11 based on the control information received from the vehicle charging management device 10.

For example, the charging control ECU reduces the charging rate to perform charging at the charging rate set by the vehicle charging management device 10. Alternatively, the charging control ECU sets a charging rate based on the difference received from the vehicle charging management device 10 and reduces the charging rate to perform charging at the set charging rate.

In a case where the vehicle charging management device 10 includes the charging control ECU, the vehicle charging management device 10 need not transmit the control information the charging control ECU. In this case, the vehicle charging management device 10 reduces the charging rate by limiting the charging current to flow to the on-board battery 11 based on the control information.

In Step S204, the vehicle charging management device 10 monitors whether the contents that are being played back are either stopped or changed. In Step S205, the vehicle charging management device 10 determines whether the content playback has ended.

The vehicle charging management device 10 repeats the process of Steps S204 and S205 until determination is made in Step S205 that the content playback has ended.

When determination is made in Step S204 that the contents that are being played back are either stopped or changed before the end of the content playback, the vehicle charging management device 10 returns to Step S201 from Step S204 and repeats the process of Step S201 and subsequent steps.

For example, when determination is made in Step S204 that the contents are stopped, the vehicle charging management device 10 performs the process of Step S201 in response to resumption of the playback of the stopped contents. In Step S201, the process is performed by acquiring the remaining content playback period at the time of resumption of the content playback and the remaining charging period at the time of determination.

When determination is made in Step S204 that the contents are changed, the vehicle charging management device 10 performs the process of Step S201 in response to playback of the changed contents. In Step S201, the process is performed by acquiring the remaining playback period of the changed contents and the remaining charging period at the time of determination.

When determination is made in Step S205 that the content playback has ended, the vehicle charging management device 10 terminates the process of FIG. 3.

According to the embodiment described above, the following effects are attained.

The vehicle charging management device 10 of the embodiment performs the process for acquiring the remaining charging period of the battery (on-board battery 11) of the vehicle 1 up to the target charge level, the process for acquiring the remaining playback period until the end of the content playback in the vehicle 1, and the charging rate control process for controlling the charging rate of the battery (on-board battery 11) to decrease when the remaining charging period is shorter than the remaining playback period (see Steps S201 to S203 in FIG. 3).

When the remaining charging period is shorter than the remaining playback period, the charging rate of the on-board battery 11 is reduced to extend the remaining charging period. Thus, the charging can be controlled appropriately when the contents are played back during the charging.

For example, when the remaining playback period is longer than the remaining charging period, the contents are still played back after the charging is completed. Therefore, the charge level may decrease when the content playback has ended. In the embodiment, the decrease in the charge level at the end of the content playback can be reduced by extending the remaining charging period through the charging rate control process. Further, the load on the on-board battery 11 can be reduced and deterioration of the on-board battery 11 can be suppressed by low-rate charging through the charging rate control process.

For example, the charging rate of the vehicle may be reduced to reduce the amount of electric power to be supplied to the vehicle in a case where a vehicle expected to perform quick charging is present at charging equipment such as a charging stand having a predetermined power supply capacity. When the charging rate control process is performed in this situation, electric power can be supplied with priority to the vehicle expected to perform quick charging. The vehicle charging management device 10 may transmit and receive information for the charging control by communicating with the other vehicle or a control device of the charging equipment via the communicator 18.

In the embodiment, when the remaining charging period is shorter than the remaining playback period, the control for setting the charging rate based on the difference between the remaining charging period and the remaining playback period is performed as the charging rate control process (see Steps S202 and S203 in FIG. 3).

By setting the charging rate based on the difference between the remaining charging period and the remaining playback period to eliminate the difference, the remaining charging period becomes substantially equal to the remaining playback period. Therefore, the charging of the on-board battery 11 is completed substantially simultaneously with the end of the content playback. Thus, the decrease in the charge level at the end of the content playback can further be reduced. Accordingly, the user can manage the desired charge level of the on-board battery 11 at the time of departure.

In the embodiment, the vehicle charging management device 10 performs the recommendation presenting process for recommending playback of contents with the remaining playback period longer than the remaining charging period (see Step S103 in FIG. 2).

Therefore, the playback of contents with the remaining playback period longer than the remaining charging period is recommended. When the user plays back such contents, the charging rate control process of Step S203 in FIG. 3 is performed to reduce the charging rate of the on-board battery 11. Thus, the deterioration of the on-board battery 11 can further be suppressed.

In the embodiment, when determination is made in Step S201 in FIG. 3 that the remaining charging period is not shorter than the remaining playback period (i.e., the remaining charging period is equal to or longer than the remaining playback period), the vehicle charging management device 10 terminates the process of FIG. 3.

When determination is made in Step S201 that the remaining charging period is not shorter than the remaining playback period, the vehicle charging management device 10 may perform the recommendation presenting process for recommending playback of contents with the remaining playback period longer than the remaining charging period (see Step S103 in FIG. 2) instead of terminating the process of FIG. 3.

Even when the remaining charging period is equal to or longer than the remaining playback period, the playback of contents with the remaining playback period longer than the remaining charging period is recommended. When the user plays back such contents, the charging rate control process is performed to reduce the charging rate of the on-board battery 11, thereby extending the remaining charging period.

When the remaining charging period is equal to or longer than the remaining playback period of contents selected by the user, the user need not extend the remaining charging period. However, the charging rate of the battery may be reduced from the viewpoint of suppressing the deterioration of the on-board battery 11 or performing quick charging of the other vehicle at the charging equipment.

Although the control for setting the charging rate based on the difference between the remaining charging period and the remaining playback period is performed in the embodiment, the charging rate at which the remaining charging period becomes substantially equal to the remaining playback period need not be set from the viewpoint of suppressing the deterioration of the battery as long as the charging rate is reduced through the control. For example, the charging rate may be set so that the remaining charging period becomes longer than the remaining playback period.

The vehicle charging management device 10 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the vehicle charging management device 10. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A vehicle charging management device for a vehicle, the vehicle charging management device comprising:
one or more processors; and
a storage medium storing a program configured to be executed by the one or more processors,
wherein the program comprises one or more commands, and
wherein the one or more commands cause the one or more processors to perform
a process for acquiring a remaining charging period of a battery of the vehicle up to a target charge level,
a process for acquiring a remaining playback period until an end of content playback in the vehicle, and
a charging rate control process for controlling a charging rate of the battery to decrease when the remaining charging period is shorter than the remaining playback period.

2. The vehicle charging management device according to claim 1, wherein the one or more commands cause the one or more processors to perform, as the charging rate control process, a process for performing control for setting the charging rate based on a difference between the remaining charging period and the remaining playback period when the remaining charging period is shorter than the remaining playback period.

3. The vehicle charging management device according to claim 1, wherein the one or more commands cause the one or more processors to perform a recommendation presenting process for recommending playback of contents with a remaining playback period longer than the remaining charging period.

4. The vehicle charging management device according to claim 2, wherein the one or more commands cause the one or more processors to perform a recommendation presenting process for recommending playback of contents with a remaining playback period longer than the remaining charging period.

5. The vehicle charging management device according to claim 1, wherein the one or more commands cause the one or more processors to perform, when the remaining charging period is not shorter than the remaining playback period, a recommendation presenting process for recommending playback of contents with a remaining playback period longer than the remaining charging period.

6. The vehicle charging management device according to claim 2, wherein the one or more commands cause the one or more processors to perform, when the remaining charging period is not shorter than the remaining playback period, a recommendation presenting process for recommending playback of contents with a remaining playback period longer than the remaining charging period.
